(19) United States
(12) Patent Application Publication
(10) Pub. No.: US 2002/0094478 A1
(43) Pub. Date: Jul. 18, 2002

(54) Electrode with flag-shaped tab

(76) Inventor: Arthur Holland, Bloomfield Hills, MI (US)

Correspondence Address: ENERGY CONVERSION DEVICES, INC., 2956 WATERVIEW DRIVE, ROCHESTER HILLS, MI, 48309, US

(21) Appl. No.: 09/728,165

(22) Filed: Dec. 2, 2000

(51) Int. Cl. H01M 2/26; H01M 4/66

(52) U.S. Cl. 429/211; 429/218.2; 429/245

(57) ABSTRACT

An electrode for a prismatic electrochemical cell. The electrode including a flag-shaped electrode tab. The flag-shaped tab may be integrally formed with a conductive substrate as a one-piece construction.

### FIELD OF THE INVENTION

The present invention is related to electrodes for electrochemical cells. More specifically, the present invention is related to an electrode tab for a battery electrode.

### BACKGROUND OF THE INVENTION

In rechargeable electrochemical cells, weight and portability are important considerations. It is also advantageous for rechargeable cells to have long operating lives without the necessity of periodic maintenance. Rechargeable electrochemical cells are used in numerous consumer devices such as calculators, portable radios, and cellular phones. They are often configured into a sealed power pack that is designed as an integral part of a specific device. Rechargeable electrochemical cells can also be configured as larger “cell packs” or “battery packs”.

Rechargeable electrochemical cells may be classified as “nonaqueous” cells or “aqueous” cells. An example of a nonaqueous electrochemical cell is a lithium-ion cell which uses intercalation compounds for both anode and cathode, and a liquid organic or polymer electrolyte. Aqueous electrochemical cells may be classified as either “acidic” or “alkaline”. An example of an acidic electrochemical cell is a lead-acid cell which uses lead dioxide as the active material of the positive electrode and metallic lead, in a high-surface area porous structure, as the negative active material. Examples of alkaline electrochemical cells are nickel cadmium cells (Ni—Cd) and nickel-metal hydride cells (Ni-MH). Ni-MH cells use negative electrodes having a hydrogen storage alloy as the active material. The hydrogen storage alloy is capable of the reversible electrochemical storage of hydrogen. Ni-MH cells typically use a positive electrode having nickel hydroxide as the active material. The negative and positive electrodes are spaced apart in an alkaline electrolyte such as potassium hydroxide.

Upon application of an electrical potential across a Ni-MH cell, the hydrogen absorbing alloy active material of the negative electrode is charged by the electrochemical absorption of hydrogen and the electrochemical discharge of a hydroxyl ion, forming a metal hydride. This is shown in equation (1):

$$M + {H}_{2} O + {e}^{-} {⟷}_{discharge}^{charge} M - H + {OH}^{-} \qquad ( 1 )$$

The negative electrode reactions are reversible. Upon discharge, the stored hydrogen is released from the metal hydride to form a water molecule and release an electron.

Extensive research has been conductive into improving the electrochemical aspects of the power and charge capacity of rechargeable batteries and, in particular, the Ni-MH prismatic batteries. This is discussed in detail in U.S. Pat. Nos. 5,096,667, 5,104,617, 5,238,756, and 5,277,999, the contents of which are specifically incorporated by reference.

Comparatively less time has been spent in improving the mechanical and physical aspects of the battery. In electric and hybrid vehicles both weight and size of the battery are important. One particular area in need of improvement is the electrode-terminal-external connector area.

### SUMMARY OF THE INVENTION

Disclosed herein is an electrode for an electrochemical cell, comprising: an electrode plate including an active electrode material; and a substantially flag-shaped electrode tab affixed to the plate.

Also disclosed herein is an electrode for an electrochemical cell, comprising: a conductive substrate; an active material affixed to the substrate; and an electrode tab integrally formed with the substrate as a one-piece construction.

Also disclosed herein is an electrochemical cell, comprising: at least one positive electrode and at least one negative electrode, each of the electrodes including a substantially flag-shaped electrode tab.

### BRIEF DESCRIPTION OF THE DRAWINGS

FIG. 1 is a drawing of an electrode with a flag-shaped electrode tab;

FIG. 2 is a drawing of an electrode with a flag-shaped electrode tab integrally formed with the electrode substrate as a one-piece construction; and

FIG. 3 is a drawing of a prismatic battery comprising the flag-shaped electrode tab of the present invention.

### DETAILED DESCRIPTION OF THE INVENTION

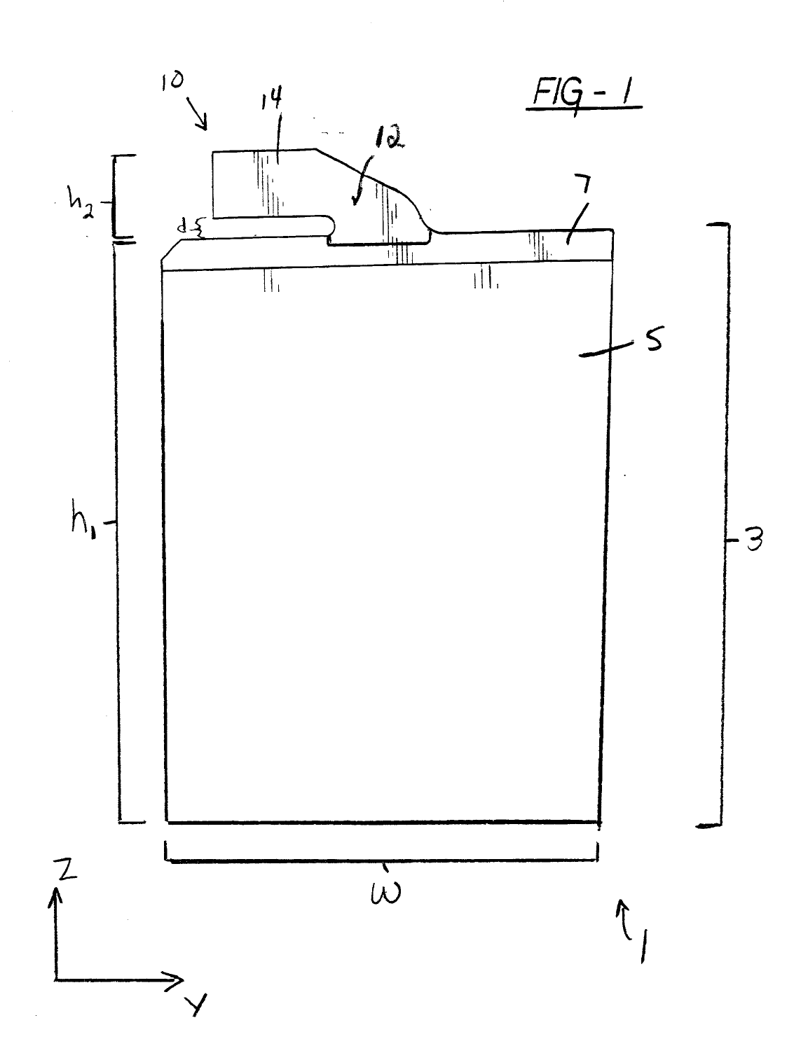

Referring now the drawings, wherein the showings are for purposes of illustrating embodiments of this invention and not for purposes of limiting same, FIG. 1 shows an electrode 1 of the present invention. The electrode 1 comprises an electrode plate 3 and a substantially flag-shaped electrode tab 10 which is affixed to the electrode plate 3.

The electrode plate 3 shown in FIG. 1 is a substantially substantially flat and substantially rectangular plate suitable for use in a prismatic electrochemical cell. The electrode plate 3 has a height “h₁” and a width “w”. The plate 3 is oriented so that the height “h₁” of the plate is substantially parallel to a longitudinal “z” axis while the width “w” is substantially parallel to a lateral “y” axis. The electrode plate also has a thickness “t” (not shown) which is perpendicular to the plane of the illustration and parallel to an “x” axis. It is noted that, in general, the height and width can be any size so that the height may be larger than the width, the height may be smaller than the width, or the height and width may be the same size.

The electrode plate 3 includes the active electrode material 5. The active electrode material 5 may be either an active positive electrode material or an active negative electrode material. Examples of positive electrode materials are powders of lead oxide, lithium cobalt dioxide, lithium nickel dioxide, lithium nickel dioxide, lithium manganese oxide compounds, lithium vanadium oxide compounds, lithium iron oxide, lithium compounds, i.e., complex oxides of these compounds and transition metal oxides, manganese dioxide, zinc oxide, nickel oxide, nickel hydroxide, manganese hydroxide, copper oxide, molybdenum oxide, carbon fluoride, etc. Preferably, the active positive electrode material is a nickel hydroxide. Examples of active negative electrode materials include metallic lithium and like alkali metals, alloys thereof, alkali metal absorbing carbon materials, zinc, cadmium hydroxide, hydrogen storage alloys, etc. Preferably, the active negative electrode material is a hydrogen storage alloy.

The electrode plate 3 may be formed by affixing the active electrode material onto a conductive substrate 7. The conductive substrate may be any electrically conductive support structure that can be used to hold the active composition. Examples of substrates include foam, grid, mesh, plate, foil, expanded metal, perforated metal or any other type of support structure. The actual form of the substrate used may at least partially depend on whether the substrate is used for the positive or the negative electrode, the type of active material used, whether it is paste type or non-paste type, etc. The conductive substrate may comprise any electrically conductive material. Examples of materials that may be used include nickel, nickel alloy, copper, copper alloy, copper (or copper alloy) plated with nickel (or nickel alloy), steel (such as stainless steel), and steel plated with nickel (or nickel alloy). The actual material used for the substrate depends upon many factors including whether the substrate is being used as the positive or negative electrode, the potential at which the electrode is maintained as well as the pH of the electrolyte of the electrochemical cell.

The active electrode material may be affixed to the conductive substrate in many different ways. In one method, a dry active material powder may be compacted onto the substrate by a compaction device such as a rolling mill. In another method, the active material powder may first be dry mixed with a powdered binder to form a powdered active composition which is then compacted onto the substrate. In yet another method, the active material may first be wet mixed with a binder and a solvent to form an active composition paste. The paste may then be applied to the substrate to form the electrode plate. In addition, the electrode plate may then be compacted to reduce its thickness.

The electrode 1 includes a substantially flag-shaped electrode tab 10 which is affixed to the electrode plate 3. In the embodiment shown in FIG. 1, the electrode tab 10 is affixed directly to the conductive substrate 7. As well, in the embodiment shown in FIG. 1, the electrode tab 10 and the conductive substrate 7 are separate pieces and the electrode tab 10 is mechanically secured directly to the conductive substrate 7. This may be done in different ways including, but not limited to, welding, brazing and soldering. Preferably, the electrode tab 10 is mechanically secured to the substrate 7 by welding. Forms of welding include, but are not limited to, resistance welding, laser welding and ultrasonic welding.

Generally, the electrode tab 10 may be formed from any conductive material. Examples of materials which may be used include nickel, nickel alloy, copper, copper alloy, copper (or copper alloy) plated with nickel (or nickel alloy), steel (such as stainless steel), and steel plated with nickel (or nickel alloy). The materials chosen for the flag-shaped tab may depend upon whether the tab is being used for the positive or the negative electrode.

The flag-shaped tab 10 includes a “connector” portion 12 which connects to the electrode plate 3 and which extends outwardly, away from an edge of the electrode plate 3. The tab 10 further includes a “flag” portion, spacedly disposed from the electrode plate 3. As shown in FIG. 1, the flag portion 14 preferably points in a direction transverse to its displacement “d” from the edge of the electrode plate. More preferably, the flag portion points in a direction which is substantially perpendicular to its displacement from the electrode plate. In the embodiment of FIG. 1, the flag portion 14 is spacedly disposed above the top edge electrode plate and points in a substantially horizontal direction. The flag-shaped tab 10 has a height h₂. The “total” electrode height is the height of the electrode plate h₁plus the height of the tab h₂.

The flag-shaped tab 10 may be manufactured as a substantially flat piece. However, it is preferable that the tab be flexible so that the flag portion 14 can be flexed or bent about the connector portion 12. Such flexibility helps to connect the flag portion of the tab to either positive or negative electrode terminal. In the embodiment shown, the flag portion 14 may be flexed or bent about the longitudinal “z” axis while the connector portion 12 may be flexed or bent about the lateral “y” axis.

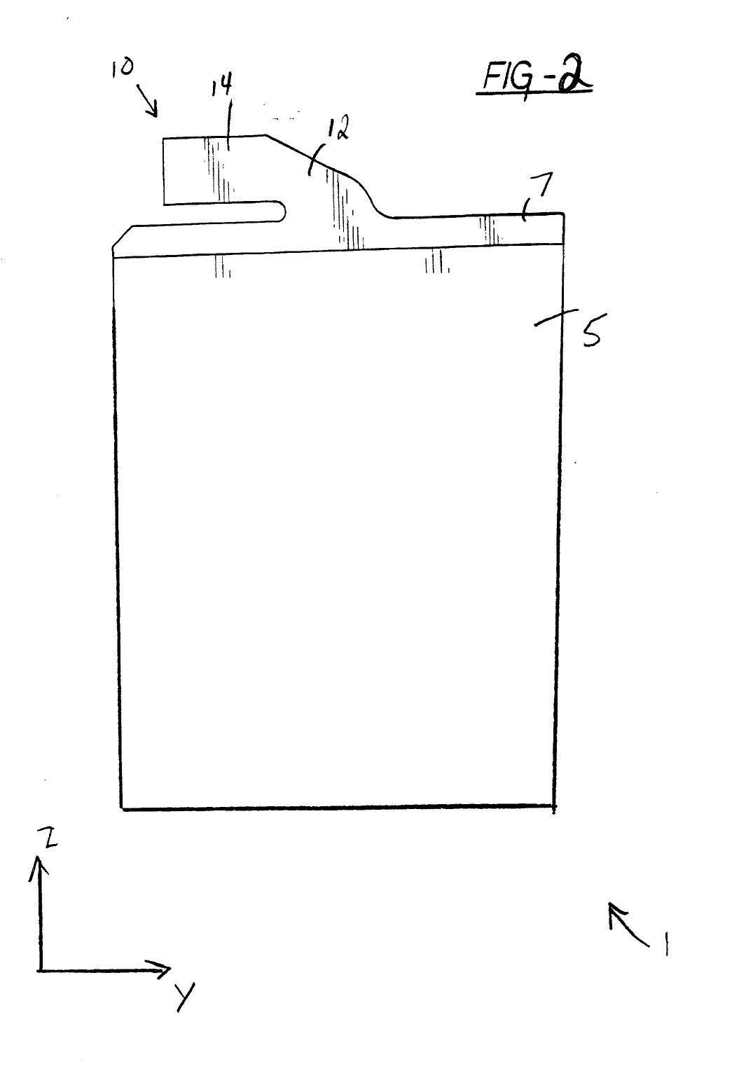

In the embodiment shown in FIG. 1, the electrode tab 10 and the substrate 7 are separate pieces that are coupled together. In an alternate embodiment of the invention the tab 10 and the substrate 7 may be integrally formed as a one-piece construction. This embodiment is shown in FIG. 2. The tab 10 and the substrate 7 may be stamped from the same piece of metal. Forming the tab and the substrate as a single piece provides for increased structural integrity as well as improved manufacturability.

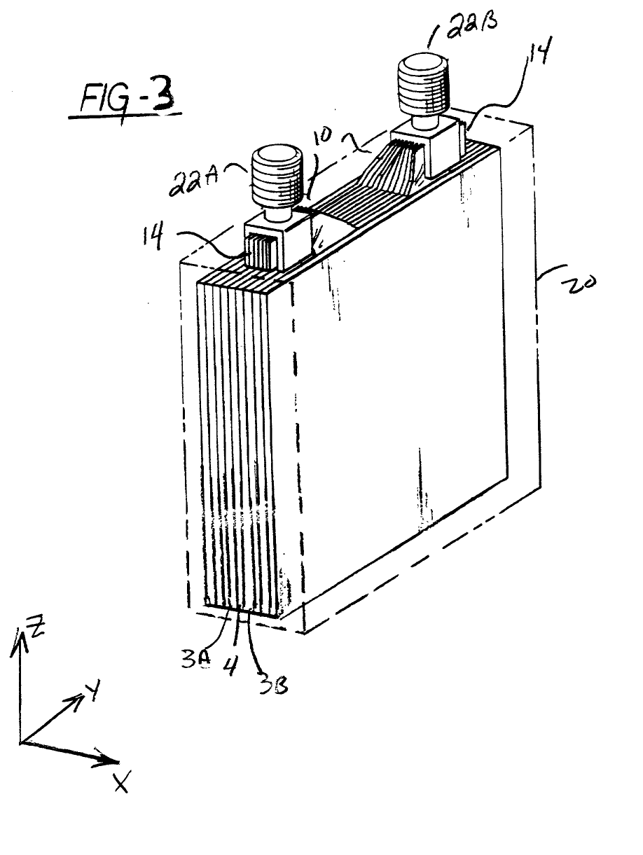

FIG. 3 shows an electrochemical cell that comprises at least one positive electrode 3A and at least one negative electrode 3B. The positive and negative electrodes are separated by separators 4. The electrodes 3A, 3B and the separators 4 are wetted by an electrolyte.

Generally, the electrolyte may be an aqueous or a nonaqueous electrolyte. The aqueous electrolyte may be either “acidic” or “alkaline”. Preferably, the electrochemical cells are alkaline electrochemical cells. The alkaline electrolyte may be an aqueous solution of an alkali hydroxide. Preferably, the alkaline electrolyte includes an aqueous solution of potassium hydroxide, sodium hydroxide, lithium hydroxide or mixtures thereof. The alkaline electrolyte may be a mixed hydroxide of potassium and lithium hydroxide. In the one embodiment of the present invention, the alkaline electrochemical cell is a nickel-metal hydride cell (Ni-MH) having negative electrodes comprising a hydrogen storage material that can electrochemically and reversibly store hydrogen, and positive electrodes comprising a nickel hydroxide active material.

The electrodes are inserted into a prismatic battery case 20. Each of the electrodes 3A, 3B includes the flag-shaped electrode tab 10 of the present invention. The electrode tabs 10 that are affixed to the positive electrodes 3A are also all connected to the positive terminal 22A. Likewise, the electrode tabs 10 that are affixed to the negative electrodes 3B are also all connected to the negative terminal 22B. The flag portions 14 of the positive electrode tabs 10 are connected to the positive terminal 22A. Likewise, the flag portions 14 of the negative electrode tabs 10 are connected to the negative terminal 22B. The flexibility of the flag portions 14 about the longitudinal “z” axis and the flexibility of the connector portion about the lateral “y” axis make the flag-shaped tabs easy to connect to the appropriate battery terminal. The increased flexibility also allows the tabs to move more freely in response to external vibrations as well as movements and dimensional changes of the electrode plates, thus relieving mechanical stress, decreasing the chance for tab buckling and connection breakage, and increasing battery reliability.

The flag-shaped tabs 10 also provide for a smaller total electrode height. Because of the curved shape of the tabs, they do not have to extend as high in order for them to make good connection with the battery terminals. Hence, the total height of the electrode (the height h₁ of the electrode plate plus the height h₂ of the tab, as shown in FIG. 1) is less than the total height of an electrode using a conventional “straight” electrode tab. This provides for an overall shorter battery which takes up less head room and which can be fit into smaller spaces. This is especially important for electric and hybrid vehicle applications.

The disclosure set forth herein is presented in the form of detailed embodiments described for the purpose of making a full and complete disclosure of the present invention, and such details are not to be interpreted as limiting the true scope of the invention as set forth and defined in the claims below.

We claim:

1. An electrode for an electrochemical cell, comprising:
an electrode plate including an active electrode material; and
a substantially flag-shaped electrode tab affixed to said plate.

2. The electrode of claim 1, wherein said tab includes a connector portion affixed to said plate and a flag portion spacedly disposed from said plate.

3. The electrode of claim 1, wherein said active electrode material is affixed to a conductive substrate.

4. The electrode of claim 3, wherein said tab is integrally formed with said substrate as a one-piece construction.

5. The electrode of claim 1, wherein said electrode plate is substantially flat.

6. The electrode of claim 1, wherein said active electrode material is a hydrogen storage alloy.

7. The electrode of claim 1, wherein said active electrode material is a nickel hydroxide material.

8. The electrode of claim 1, wherein said tab comprises a material selected from the group consisting of nickel, nickel alloy, copper, copper alloy, and steel.

9. An electrode for an electrochemical cell, comprising:
a conductive substrate;
an active material affixed to said substrate; and
an electrode tab integrally formed with said substrate as a one-piece construction.

10. The electrode of claim 9, wherein said active electrode material is a hydrogen storage alloy.

11. The electrode of claim 9, wherein said active electrode material is a nickel hydroxide material.

12. The electrode of claim 9, wherein said tab comprises a material selected from the group consisting of nickel, nickel alloy, copper, copper alloy, and steel.

13. The electrode of claim 9, wherein said electrode is substantially flat.

14. An electrochemical cell, comprising:
at least one positive electrode and at least one negative electrode, each of said electrodes including a substantially flag-shaped electrode tab.

15. The electrochemical cell of claim 14, wherein said positive electrode includes an active electrode material affixed to a conductive substrate.

16. The electrochemical cell of claim 15, wherein said active electrode material is a nickel hydroxide material.

17. The electrochemical cell of claim 15, wherein said electrode tab and said substrate are a one-piece construction.

18. The electrochemical cell of claim 14, wherein said negative electrode includes an active electrode material affixed to a conductive substrate.

19. The electrochemical cell of claim 18, wherein said active material is a hydrogen storage alloy material.

20. The electrochemical cell of claim 18, wherein said electrode tab and said conductive substrate are a one-piece construction.

21. The electrochemical cell of claim 14, wherein said cell is a prismatic cell.

22. The electrode of claim 1, wherein said tab comprises a material selected from the group consisting of nickel, nickel alloy, copper, copper alloy, and steel.
